(19) United States
(12) Patent Application Publication
(10) Pub. No.: US 2024/0287260 A1
(43) Pub. Date: Aug. 29, 2024

(54) SOFT THERMOPLASTIC COMPOSITION

(71) Applicant: SOLVAY SPECIALTY POLYMERS ITALY S.P.A., Bollate (IT)

(72) Inventors: Mattia BASSI, Milano (IT); Martina CORASANITI, Caronno Pertusella (IT); Laura PONTA, Milano (IT)

(21) Appl. No.: 17/280,317

(22) PCT Filed: Oct. 1, 2019
(86) PCT No.: PCT/EP2019/076607

§ 371 Date: Mar. 26, 2021

(30) Foreign Application Priority Data
Oct. 2, 2018 (EP) 18198375.0

(51) Int. Cl. C08J 3/00; C08L 27/16

(52) U.S. Cl. CPC C08J 3/005; C08L 27/16; C08J 2327/16; C08J 2427/16; C08L 2201/52; C08L 2205/025; C08L 2207/04

(57) ABSTRACT

The present invention pertains to a method of making a latex-blended composition of a fluorinated thermoplastic elastomer and of a (per)fluoroelastomer, to the composition obtained therefrom, and to the use of the same for making shaped parts, said composition possessing an improved softness/mechanical properties compromise.

### CROSS-REFERENCE TO RELATED APPLICATION

This application claims priority to European application No. 18198375.0 filed Oct. 2, 2018, the whole content of this application being incorporated herein by reference for all purposes.

### TECHNICAL FIELD

The present invention relates to a composition based on a fluorinated thermoplastic elastomer possessing increased softness, to methods for the manufacture of the same, and to the use thereof in a variety of fields of use.

### BACKGROUND ART

Fluorinated thermoplastic elastomers are known in the art; these materials combine the advantageous processability and recyclability attributes of a thermoplast, while behaving as a rubber, enabling fulfilling elasticity/rubbery requirements of elastomers, so as to be suitably used as sealing materials, in gaskets, for flexible hoses, etc.

As known, thermoplastic elastomers are block copolymers consisting of at least one “soft” segment having elastomeric properties and at least one “hard” segment having thermoplastic properties.

In particular, fluorinated thermoplastic elastomers having improved mechanical and elastic properties by the introduction in the polymeric chain of small amounts of a bis-olefin are described, for instance, in U.S. Pat. No. 5,612,419 (AUSIMONT S.P.A.) 18 Mar. 1997.

Also, fluorinated thermoplastic elastomers having improved mechanical and elastic properties by the introduction in the polymeric chain of small amounts of an iodinated olefin are described, for instance, in U.S. Pat. No. 5,605,971 (AUSIMONT S.P.A.) 25 Feb. 1997.

Additional fluorinated thermoplastic elastomers are disclosed in EP 1029875 A 23 Aug. 2000, whereas a multi-segment polymer having an elastomeric fluorine-containing polymer chain segment, and a non-elastomeric fluorine-containing polymer chain, in which said elastomeric fluorine-containing polymer chain segment has perhaloolefin units as recurring unit, and more specifically has tetrafluoroethylene as recurring unit.

Further, WO 2018/050688 (SOLVAY SPECIALTY POLYMERS ITALY S.P.A.) 22 Mar. 2018 describes fluorinated thermoplastic elastomer comprising a soft block made of a fluoroelastomer free from tetrafluoroethylene units and a hard block comprising units derived from vinylidene fluoride.

Now, inherently, thermoplastic elastomers possess a certain crystalline fraction, associated to the thermoplastic segment, which is necessarily present to ensure the physical crosslinking between the amorphous chains; so, inherently thermoplastic elastomers have certain hardness, which may be unacceptable in certain fields of use whereas softer rubbers are required, e.g. down to about 70 Shore A or lower.

Subject matter of the present invention hereby involved addresses the problem of reducing hardness of fluorinated thermoplastic elastomer materials for fulfilling unmet market needs for softer materials.

### BRIEF DESCRIPTION OF DRAWINGS

FIG. 1 is a recollection of SEM microscopy magnifications of a latex blended composition according to the invention (Ex. 2).

FIG. 2 is a recollection of SEM microscopy magnifications of a comparative composition prepared by solid mixing (Ex. 3C).

### SUMMARY OF INVENTION

The invention thus pertains to a method of making a latex-blended composition [composition (C)] comprising:
a Step (A) a step of mixing:
   an aqueous latex of at least one fluorinated thermoplastic elastomer [polymer (F-TPE)] comprising:
(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418, and
(ii) at least one thermoplastic block (B) consisting of a sequence of recurring units, said sequence comprising recurring units derived from at least one fluorinated monomer,
wherein the crystallinity of said block (B) and its weight fraction in the polymer (F-TPE) are such to provide for a heat of fusion of the polymer (F-TPE) of at least 2.5 J/g, when determined according to ASTM D3418; and
   an aqueous latex of at least one (per)fluoroelastomer [elastomer (F)] possessing a heat of fusion of less than 2.5 J/g, when determined according to ASTM D3418;
so as to obtain a latex mixture [mixture (L)]; and
a Step (B) of coagulating the said mixture (L), so as to obtain said composition (C).

The invention further pertains to a latex-blended composition obtained from the method as detailed above.

The Applicant has found that the method as above detailed is essential for manufacturing a composition whereas the intimate mixing among the elastomer (F) and the polymer (F-TPE) is such to deliver a composition possessing increased softness or, otherwise said, lower hardness, while ensuring better mechanical performances, in particular higher tensile strength and higher elongation at break, over similar material possessing similar monomers' content, but obtained through alternated methodologies.

In particular, as explained in more detail herein below, the Applicant has found that the method of latex blending is such to deliver a soft material possessing better mechanical properties at similar hardness, as determined by Shore A values, than a material solely made of a polymer (F-TPE), whereas the fractions of elastomeric block(s) (A) and thermoplastic block(s) (B) have been arranged through increase of the former to fit the said Shore A value.

Further, the Applicant has surprisingly found that solely mixing by latex blending is effective in ensuring an intimate mixing among the elastomer (F) and the polymer (F-TPE), so delivering a peculiar composition morphology/micro-structure whereas compatibility and cohesion among the two materials is achieved, which is not achieved through compounding of solid materials, e.g. by mixing in open mill: result of such traditional compounding of elastomer (F) and polymer (F-TPE) at similar weight ratios as per the latex blending approach has been found less effective in decreasing hardness and causing mechanical performances to be detrimentally affected.

Finally, the Applicant has surprisingly found that the choice of elastomer (F) and the polymer (F-TPE), and more specifically, the block structure of this latter polymer (F-TPE) in this latex blending method is key for achieving the sought balance of performances, being understood that the compromise of softness and mechanical performances is not achieved when mixing, be it through latex blending or otherwise, the elastomer (F) and a thermoplastic polymer, in an amount corresponding to the thermoplastic block(s) (B) fraction of polymer (F-TPE).

### DESCRIPTION OF EMBODIMENTS

### The Polymer (F-TPE)

For the purpose of the present invention, the term “elastomeric”, when used in connection with the “block (A)” is hereby intended to denote a polymer chain segment which, when taken alone, is substantially amorphous, that is to say, has a heat of fusion of less than 2.0 J/g, preferably of less than 1.5 J/g, more preferably of less than 1.0 J/g, as measured according to ASTM D3418.

For the purpose of the present invention, the term “thermoplastic”, when used in connection with the “block (B)”, is hereby intended to denote a polymer chain segment which, when taken alone, is semi-crystalline, and possesses a detectable melting point, with an associated heat of fusion of exceeding 10.0 J/g, as measured according to ASTM D3418.

The fluorinated thermoplastic elastomer of the composition (C) of the invention is advantageously a block copolymer, said block copolymer typically having a structure comprising at least one block (A) alternated to at least one block (B), that is to say that said fluorinated thermoplastic elastomer typically comprises, preferably consists of, one or more repeating structures of type (B)-(A)-(B). Generally, the polymer (F-TPE) has a structure of type (B)-(A)-(B), i.e. comprising a central block (A) having two ends, connected at both ends to a side block (B).

The block (A) is often alternatively referred to as soft block (A); the block (B) is often alternatively referred to as hard block (B).

The term “fluorinated monomer” is hereby intended to denote an ethylenically unsaturated monomer comprising at least one fluorine atom.

The fluorinated monomer may further comprise one or more other halogen atoms (Cl, Br, I).

Any of block(s) (A) and (B) may further comprise recurring units derived from at least one hydrogenated monomer, wherein the term “hydrogenated monomer” is intended to denote an ethylenically unsaturated monomer comprising at least one hydrogen atom and free from fluorine atoms.

The polymer (F-TPE) typically comprises, preferably consists of:
at least one elastomeric block (A) selected from the group consisting of:
(1) vinylidene fluoride (VDF)-based elastomeric blocks (A_{VDF}) consisting of a sequence of recurring units, said sequence comprising recurring units derived from VDF and recurring units derived from at least one fluorinated monomer different from VDF, said fluorinated monomer different from VDF being typically selected from the group consisting of:
(a) C₂-C₈ perfluoroolefins such as tetrafluoroethylene (TFE), hexafluoropropylene (HFP);
(b) hydrogen-containing C₂-C₈ fluoroolefins different from VDF, such as vinyl fluoride, trifluoroethylene (TrFE), hexafluoroisobutylene (HFIB), perfluoroalkyl ethylenes of formula CH₂═CH—R_{f1}, wherein R_{f1} is a C₁-C₆ perfluoroalkyl group;
(c) C₂-C₈ chloro- and/or bromo-containing fluoroolefins such as chlorotrifluoroethylene (CTFE);
(d) perfluoroalkylvinylethers (PAVE) of formula CF₂═CFOR_{f1}, wherein R_{f1} is a C₁-C₆ perfluoroalkyl group, such as CF₃ (PMVE), C₂F₅ or C₃F₇;
(e) perfluorooxyalkylvinylethers of formula CF₂═CFOX₀, wherein X₀ is a a C₁-C₁₂ perfluorooxyalkyl group comprising one or more than one ethereal oxygen atom, including notably perfluoromethoxyalkylvinylethers of formula CF₂═CFOCF₂OR_{f2}, with R_{f2} being a C₁-C₃ perfluoro(oxy)alkyl group, such as —CF₂CF₃, —CF₂CF₂—O—CF₃ and —CF₃; and
(f) (per)fluorodioxoles of formula:

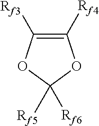

wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms, such as —CF₃, —C₂F₅, —C₃F₇, —OCF₃ or —OCF₂CF₂OCF₃; and
(2) tetrafluoroethylene (TFE)-based elastomeric blocks (A_{TFE}) consisting of a sequence of recurring units, said sequence comprising recurring units derived from TFE and recurring units derived from at least one fluorinated monomer different from TFE, said fluorinated monomer being typically selected from the group consisting of those of classes (b), (c), (d), (e) as defined above;
at least one thermoplastic block (B) consisting of a sequence of recurring units derived from at least one fluorinated monomer.

Any of block(s) (A_{VDF}) and (A_{TFE}) may further comprise recurring units derived from at least one hydrogenated monomer, which may be selected from the group consisting of C₂-C₈ non-fluorinated olefins such as ethylene, propylene or isobutylene.

The elastomeric block (A) is preferably a block (A_{VDF}), as above detailed, said block (A_{VDF}) typically consisting of a sequence of recurring units comprising, preferably consisting of:
from 45% to 80% by moles of recurring units derived from vinylidene fluoride (VDF),
from 5% to 50% by moles of recurring units derived from at least one fluorinated monomer different from VDF,
optionally, up to 1.0% by moles of recurring units derived from at least one bis-olefin (OF), as above detailed; and
optionally, up to 30% by moles of recurring units derived from at least one hydrogenated monomer,
with respect to the total moles of recurring units of the sequence of block (A_{VDF}).

The elastomeric block (A) may further comprise recurring units derived from at least one bis-olefin [bis-olefin (OF)] of formula:

R_{A}R_{B}═CR_{C}-T-CR_{D}═R_{E}R_{F}
wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, preferably at least partially fluorinated, or a (per)fluoropolyoxyalkylene group.

The bis-olefin (OF) is preferably selected from the group consisting of those of any of formulae (OF-1), (OF-2) and (OF-3):

### (OF-1)

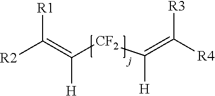 [0057] wherein j is an integer comprised between 2 and 10, preferably between 4 and 8, and R1, R2, R3 and R4, equal to or different from each other, are selected from the group consisting of H, F, C₁-C₅ alkyl groups and C₁-C₅ (per)fluoroalkyl groups;

### (OF-2)

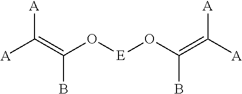 [0059] wherein each of A, equal to or different from each other and at each occurrence, is independently selected from the group consisting of H, F and Cl; each of B, equal to or different from each other and at each occurrence, is independently selected from the group consisting of H, F, Cl and OR_{B}, wherein R_{B} is a branched or straight chain alkyl group which may be partially, substantially or completely fluorinated or chlorinated, E is a divalent group having 2 to 10 carbon atoms, optionally fluorinated, which may be inserted with ether linkages; preferably E is a —(CF₂)ₘ— group, wherein m is an integer comprised between 3 and 5; a preferred bis-olefin of (OF-2) type is F₂C═CF—O—(CF₂)₅—O—CF═CF₂;

### (OF-3)

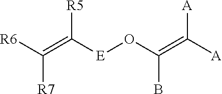 [0061] wherein E, A and B have the same meaning as defined above, R5, R6 and R7, equal to or different from each other, are selected from the group consisting of H, F, C₁-C₅ alkyl groups and C₁-C₅ (per)fluoroalkyl groups.

Should the block (A) consist of a recurring units sequence further comprising recurring units derived from at least one bis-olefin (OF), said sequence typically comprises recurring units derived from the said at least one bis-olefin (OF) in an amount comprised between 0.01% and 1.0% by moles, preferably between 0.03% and 0.5% by moles, more preferably between 0.05% and 0.2% by moles, based on the total moles of recurring units of block (A).

Block (B) may consist of a sequence of recurring units, said sequence comprising:
recurring units derived from one or more than one fluoromonomer, preferably selected from the group consisting of:
(a) C₂-C₈ perfluoroolefins such as tetrafluoroethylene (TFE), hexafluoropropylene (HFP);
(b) hydrogen-containing C₂-C₈ fluoroolefins, such as vinylidene fluoride (VDF), vinyl fluoride, trifluoroethylene (TrFE), hexafluoroisobutylene (HFIB), perfluoroalkyl ethylenes of formula CH₂═CH—R_{f1}, wherein R_{f1} is a C₁-C₆ perfluoroalkyl group;
(c) C₂-C₈ chloro- and/or bromo-containing fluoroolefins such as chlorotrifluoroethylene (CTFE);
(d) perfluoroalkylvinylethers (PAVE) of formula CF₂═CFOR_{f1}, wherein R_{f1} is a C₁-C₆ perfluoroalkyl group, such as CF₃ (PMVE), C₂F₅ or C₃F₇;
(e) perfluorooxyalkylvinylethers of formula CF₂═CFOX₀, wherein X₀ is a C₁-C₁₂ perfluorooxyalkyl group comprising one or more than one ethereal oxygen atom, including notably perfluoromethoxyalkylvinylethers of formula CF₂═CFOCF₂OR_{f2}, with R_{f2} being a C₁-C₃ perfluoro(oxy)alkyl group, such as —CF₂CF₃, —CF₂CF₂—O—CF₃ and —CF₃; and
(f) (per)fluorodioxoles of formula:

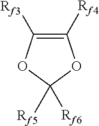

wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms, such as —CF₃, —C₂F₅, —C₃F₇, —OCF₃ or —OCF₂CF₂OCF₃; and
optionally, recurring units derived from one or more than one hydrogenated monomer, as above detailed, including notably ethylene, propylene, (meth)acrylic monomers, styrenic monomers.

More specifically, block (B) may be selected from the group consisting of:
blocks (B_{VDF}) consisting of a sequence of recurring units derived from vinylidene fluoride and optionally from one or more than one additional fluorinated monomer different from VDF, e.g. HFP, TFE or CTFE, and optionally from a hydrogenated monomer, as above detailed, e.g. a (meth)acrylic monomer, whereas the amount of recurring units derived from VDF is of 85 to 100% moles, based on the total moles of recurring units of block (B_{VDF});
blocks (B_{TFE}) consisting of a sequence of recurring units derived from tetrafluoroethylene, and optionally from an additional perfluorinated monomer different from TFE, whereas the amount of recurring units derived from TFE is of 75 to 100% moles, based on the total moles of recurring units of block (B);
blocks (B_{E/(C)TFE}) consisting of a sequence of recurring units derived from ethylene and recurring units derived from CTFE and/or TFE, possibly in combination with an additional monomer.

The weight ratio between blocks (A) and blocks (B) in the fluorinated thermoplastic elastomer is typically comprised between 95:5 and 10:90.

According to certain preferred embodiments, the polymers (F-TPE) comprise a major amount of blocks (A); according to these embodiment's, the polymer (F-TPE) used in the method of the present invention is characterized by a weight ratio between blocks (A) and blocks (B) of 95:5 to 65:35, preferably 90:10 to 70:30.

The crystallinity of block (B) and its weight fraction in the polymer (F-TPE) are such to provide for a heat of fusion (ΔH_{f}) of the polymer (F-TPE) of advantageously at most 20 J/g, preferably at most 18 J/g, more preferably at most 15 J/g, when determined according to ASTM D3418; on the other side, polymer (F-TPE) combines thermoplastic and elastomeric character, so as to possess a certain crystallinity, delivering a heat of fusion of at least 2.5 J/g, preferably at least 3.0 J/g.

Preferred polymers (F-TPE) for the porous membrane of the invention are those comprising:
at least one elastomeric block (A_{VDF}), as above detailed, and
at least one thermoplastic block (B_{VDF}), as above detailed, and wherein the crystallinity of said block (B) and its weight fraction in the polymer (F-TPE) are such to provide for a heat of fusion of the polymer (F-TPE) of at most 20.0 J/g, and/or of at least 5.0 J/g, when determined according to ASTM D3418.

The polymers (F-TPE) used in the method of the present invention may be manufactured by a manufacturing process comprising the following sequential steps:
(a) polymerizing at least one fluorinated monomer, and possibly at least one bis-olefin (OF), in the presence of a radical initiator and of an iodinated chain transfer agent, thereby providing a pre-polymer consisting of at least one block (A) containing one or more iodinated end groups; and
(b) polymerizing at least one fluorinated monomer, in the presence of a radical initiator and of the pre-polymer provided in step (a), thereby providing at least one block (B) grafted on said pre-polymer through reaction of the said iodinated end groups of the block (A).

### The Elastomer (F)

For the purposes of this invention, the term “(per)fluoroelastomer” or elastomer (F) is intended to designate a fluoropolymer resin serving as a base constituent for obtaining a true elastomer, said fluoropolymer resin comprising more than 10% wt, preferably more than 30% wt, of recurring units derived from at least one ethylenically unsaturated monomer comprising at least one fluorine atom (hereafter, (per)fluorinated monomer) and, optionally, recurring units derived from at least one ethylenically unsaturated monomer free from fluorine atom (hereafter, hydrogenated monomer).

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Generally elastomer (F) comprises recurring units derived from at least one (per)fluorinated monomer, wherein said (per)fluorinated monomer is generally selected from the group consisting of:
(a) C₂-C₈ perfluoroolefins, such as tetrafluoroethylene (TFE), hexafluoropropene (HFP), pentafluoropropylene, and hexafluoroisobutylene;
(b) hydrogen-containing C₂-C₈ fluoroolefins, such as vinylidene fluoride (VDF), vinyl fluoride, trifluoroethylene (TrFE), hexafluoroisobutylene (HFIB), perfluoroalkyl ethylenes of formula CH₂═CH—R_{f1}, wherein R_{f1} is a C₁-C₆ perfluoroalkyl group;
(c) chloro- and/or bromo- and/or iodo-C₂-C₆ fluoroolefins, like chlorotrifluoroethylene (CTFE);
(d) perfluoroalkylvinylethers (PAVE) of formula CF₂═CFOR_{f1}, wherein R_{f1} is a C₁-C₆ perfluoroalkyl group, such as CF₃ (PMVE), C₂F₅ or C₃F₇;
(e) perfluorooxyalkylvinylethers of formula CF₂═CFOX₀, wherein X₀ is a C₁-C₁₂ perfluorooxyalkyl group comprising one or more than one ethereal oxygen atom, including notably perfluoromethoxyalkylvinylethers of formula CF₂═CFOCF₂OR_{f2}, with R_{f2} being a C₁-C₃ perfluoro(oxy)alkyl group, such as —CF₂CF₃, —CF₂CF₂—O—CF₃ and —CF₃; and
(f) (per)fluorodioxoles of formula:

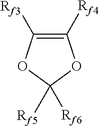

wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms, such as —CF₃, —C₂F₅, —C₃F₇, —OCF₃ or —OCF₂CF₂OCF₃.

Elastomer (F) may comprise recurring units derived from a fluorine-free monomer, and more particularly from (g) at least one C₂-C₈ non-fluorinated olefins (OI), for example ethylene and propylene.

Elastomers (F) are in amorphous products or products having a low degree of crystallinity (i.e. a heat of fusion of less than 2.5 J/g, when determined according to ASTM D3418) and a glass transition temperature (T_{g}) below room temperature. In most cases, the elastomer (F) has advantageously a T_{g} below 10° C., preferably below 5° C., more preferably 0° C.

The elastomer (F) is preferably selected among:
(1) VDF-based copolymers, in which VDF is copolymerized with at least one additional monomer selected from the group consisting of monomers (a), (b) different from VDF, (c), (d), (e), and (f), as detailed above; and
(2) TFE-based copolymers, in which TFE is copolymerized with at least one additional monomer selected from the group consisting of (a) different from TFE, (b), (c), (d), (e), and (f), as above detailed.

Elastomer (F) is generally selected among TFE-based copolymers, as above detailed.

Optionally, elastomer (F) of the present invention may also comprises recurring units derived from a bis-olefin [bis-olefin (OF)] having general formula:

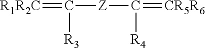

wherein R₁, R₂, R₃, R₄, R₅ and R₆, equal or different from each other, are H or C₁-C₅ alkyl; Z is a linear or branched C₁-C₁₈ (hydro)carbon radical (including alkylene or cycloalkylene radical), optionally containing oxygen atoms, preferably at least partially fluorinated, or a (per)fluoro(poly)oxyalkylene radical comprising one or more catenary ethereal bonds.

The bis-olefin (OF) is preferably selected from the group consisting of those complying with formulae (OF-1), (OF-2) and (OF-3):

### (OF-1)

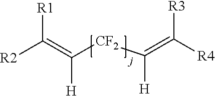 [0105] wherein j is an integer between 2 and 10, preferably between 4 and 8, and R1, R2, R3, R4, equal or different from each other, are H, F or C₁₋₅ alkyl or (per)fluoroalkyl group;

### (OF-2)

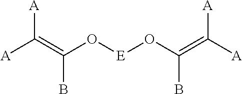 [0107] wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C═CF—O—(CF₂)₅—O—CF═CF₂.

### (OF-3)

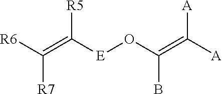 [0109] wherein E, A and B have the same meaning as above defined; R5, R6, R7, equal or different from each other, are H, F or C₁₋₅ alkyl or (per)fluoroalkyl group.

The elastomer (F) may comprise cure-sites, i.e. groups which possess peculiar reactivity towards certain cure chemistry. Cure sites may be (j) iodine and/or bromine cure sites or may be (jj) nitrile or carbo-groups, or a combination (j)+(jj) thereof.

When elastomer (F) comprises iodine and/or bromine, generally, the amount of iodine and/or bromine cure site is such that the I and/or Br content is of from 0.04 to 10.0% wt, with respect to the total weight of elastomer (F).

These iodine and/or bromine cure sites might be comprised as pending groups bound to the backbone of the elastomer (F) polymer chain or might be comprised as terminal groups of said polymer chain.

According to a first embodiment, the iodine and/or bromine cure sites are comprised as pending groups bound to the backbone of the elastomer (F) polymer chain; the elastomer (F) according to this embodiment typically comprises recurring units derived from brominated and/or iodinated cure-site comonomers selected from:
bromo and/or iodo alpha-olefins containing from 2 to 10 carbon atoms such as bromotrifluoroethylene or bromotetrafluorobutene described, for example, in U.S. Pat. No. 4,035,565 (DU PONT) 12 Jul. 1977 or other compounds bromo and/or iodo alpha-olefins disclosed in U.S. Pat. No. 4,694,045 (DU PONT) 15 Sep. 1987;
iodo and/or bromo fluoroalkyl vinyl ethers (as notably described in U.S. Pat. Nos. 454,662, 4,564,662 (MINNESOTA MINING) 14 Jan. 1986 and EP 199138 A (DAIKIN IND LTD) 29 Oct. 1986).

According to a second preferred embodiment, the iodine and/or bromine cure sites (preferably iodine cure sites) are comprised as terminal groups of the elastomer (F) polymer chain; the elastomer (F) according to this embodiment is generally obtained by addition to the polymerization medium during elastomer (F) manufacture of at least one of:
iodinated and/or brominated chain-transfer agent(s); suitable chain-transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≤x+y≤2 (see, for example, U.S. Pat. No. 4,243,770 (DAIKIN IND LTD) 6 Jan. 1981 and U.S. Pat. No. 4,943,622 (NIPPON MEKTRON KK) 24 Jul. 1990); and
alkali metal or alkaline-earth metal iodides and/or bromides, such as described notably in U.S. Pat. No. 5,173,553 (AUSIMONT SRL) 22 Dec. 1992.

Advantageously, for ensuring acceptable reactivity it is generally understood that the content of iodine and/or bromine in the elastomer (F) may be of at least 0.05% wt, preferably of at least 0.06% weight, with respect to the total weight of elastomer (F).

On the other side, amounts of iodine and/or bromine not exceeding preferably 7% wt, more specifically not exceeding 5% wt, or even not exceeding 4% wt, with respect to the total weight of elastomer (F), may be those generally selected for avoiding side reactions and/or detrimental effects on thermal stability.

When elastomer (F) comprises nitrile or carbo-groups, generally, the elastomer (F) comprises from 0.1 to 10.0% moles, with respect to total moles of recurring units of elastomer (F), of recurring units derived from at least one of:
cure-site containing monomers having at least a nitrile group [monomer (CS-N)];
cure-site containing monomers having at least a carbo-group [monomer (CS-C)] selected from the group consisting of carboxylic groups —COOH;
carboxylate groups —COOXₐ, with Xₐ being a monovalent metal or an ammonium group; carboxamide group —CONH₂; and alkoxycarboxylic group —COO—R_{H}, with R_{H} being a (fluoro)(hydro)carbon group, preferably a C₁-C₃ alkyl group.

Among cure-site containing monomers of type (CS-N), preferred monomers are (per)fluorinated and are especially those selected from the group consisting of:
(CS-N1) perfluorovinyl ethers containing nitrile groups of formula CF₂═CF—(OCF₂CFX^{CN})ₘ—O—(CF₂)ₙ—CN, with X^{CN} being F or CF₃, m being 0, 1, 2, 3 or 4; n being an integer from 1 to 12;
(CS-N2) perfluorovinyl ethers containing nitrile groups of formula CF₂═CF—(OCF₂CFX^{CN})_{m′}—O—CF₂—CF(CF₃)—CN, with X^{CN} being F or CF₃, m′ being 0, 1, 2, 3 or 4.

Specific examples of cure-site containing monomers of type CS-N1 and CS-N2 suitable to the purposes of the present invention are notably those described in U.S. Pat. No. 4,281,092 (DU PONT) 28 Jul. 1981, U.S. Pat. No. 4,281,092 (DU PONT) 28 Jul. 1981, U.S. Pat. No. 5,447,993 (DU PONT) 5 Sep. 1995 and U.S. Pat. No. 5,789,489 (DU PONT) 4 Aug. 1998. Preferred cure-site monomer (CS-N) is perfluoro(8-cyano-5-methyl-3,6-dioxa-1-octene) of formula: CF₂═CF—O—CF₂—CF(CF₃)—O—CF₂—CF₂—CN (8-CNVE).

Among cure-site containing monomers of type (CS-C), as above detailed, preferred monomers are (per)fluorinated and are especially those selected from the group consisting of:
(CS-C1) perfluorovinyl ethers containing carbo-groups of formula CF₂═CF—(OCF₂CFX^{C})ₘ—O—(CF₂)ₙ—R_{COX}, with X^{C} being F or CF₃, m being 0, 1, 2, 3 or 4; n being an integer from 1 to 12, and R_{COX} being selected from the group consisting of carboxylic groups —COOH; carboxylate groups —COOXₐ, with Xₐ being a monovalent metal or an ammonium group; carboxamide group —CONH₂; and alkoxycarboxylic group —COO—R_{H}, with R_{H} being a (fluoro)(hydro)carbon group, preferably a C₁-C₃ alkyl group; (CS-C2) perfluorovinyl ethers containing carbo-groups of formula CF₂═CF—(OCF₂CFX^{C})_{m′}—O—CF₂—CF(CF₃)—R_{COX}, with m′ being 0, 1, 2, 3 or 4, and X^{C} and R_{COX} having the meaning as defined for (CSC-1).

Preferred elastomers (F) are those selected from the group consisting of VDF-based copolymers, as above detailed, and more specifically from VDF-based copolymers having following compositions (in mol %):
(i) vinylidene fluoride (VDF) 45-85%; hexafluoropropene (HFP) 15-45%; tetrafluoroethylene (TFE) 0-30%; bis-olefin (OF) 0-5%.
(ii) vinylidene fluoride (VDF) 20-30%; hexafluoropropene (HFP) 18-27%; C₂-C₈ non-fluorinated olefins (OI) 5-30%; perfluoroalkyl vinyl ethers (PAVE) 0-35%; bis-olefin (OF) 0-5%;
(iii) vinylidene fluoride (VDF) 60-75%; hexafluoropropene (HFP) 10-25%; tetrafluoroethylene (TFE) 0-20%; perfluoroalkyl vinyl ethers (PAVE) 1-15%; bis-olefin (OF) 0-5%.

### The Aqueous Latex

The expression “aqueous latex” when used in conjunction with both polymer (F-TPE) and elastomer (F) is to be understood according to its usual meaning, i.e. to designate a stable dispersion of polymer particles in an aqueous medium, which is generally obtained by emulsion polymerization.

Hence, latexes of polymer (F-TPE) or elastomer (F) can be manufactured via known emulsion-polymerization techniques. Suitable techniques include surfactant-assisted emulsion polymerization, in particular in the presence of fluorinated surfactant, and including micro-emulsion polymerization, in a fluorinated dispersed phase stabilized with appropriate surfactant, in particular in micro-droplets of a fluorinated perfluoropolyether oil stabilized with fluorinated surfactant, e.g. perfluoropolyether carboxylate salts.

Aqueous medium is predominantly composed of water, although it may comprise minor amount of other components, including e.g. residues of initiators, (fluoro)surfactants, and/or other auxiliaries which may derive from the manufacture of the latex itself, in an amount of generally less than 5% wt., with respect to the total weight of the latex.

Generally, the latex of polymer (F-TPE) comprises the polymer (F-TPE) in an amount of at least 15% wt., preferably at least 20% wt., more preferably at least 25% wt., and/or in an amount of at most 60% wt., preferably at most 50% wt., more preferably at most 40% wt., with respect to the total weight of latex. Similarly, the latex of elastsomer (F) generally comprises the elastomer (F) in an amount of at least 15% wt., preferably at least 20% wt., more preferably at least 25% wt., and/or in an amount of at most 60% wt., preferably at most 50% wt., more preferably at most 40% wt., with respect to the total weight of latex.

The manufacturing process above detailed for manufacturing a latex of polymer (F-TPE) or a latex of elastomer (F) is hence generally carried out in aqueous emulsion polymerization according to methods well known in the art, in the presence of a suitable radical initiator.

The radical initiator is typically selected from the group consisting of:
inorganic peroxides such as, for instance, alkali metal or ammonium persulphates, perphosphates, perborates or percarbonates, optionally in combination with ferrous, cuprous or silver salts or other easily oxidable metals;
organic peroxides such as, for instance, disuccinylperoxide, tertbutyl-hydroperoxide, and ditertbutylperoxide; and
azo compounds (see, for instance, U.S. Pat. No. 2,515,628 (E. I. DU PONT DE NEMOURS AND CO.) Jul. 18, 1950 and U.S. Pat. No. 2,520,338 (E. I. DU PONT DE NEMOURS AND CO.) Aug. 29, 1950).

It is also possible to use organic or inorganic redox systems, such as persulphate ammonium/sodium sulphite, hydrogen peroxide/aminoiminomethansulphinic acid.

When manufacturing a latex of polymer (F-TPE), a multi-step method may be used, and more specifically:
a step (a) of polymerizing at least one fluorinated monomer, in the presence of a radical initiator and of an iodinated chain transfer agent, thereby providing a latex of a pre-polymer consisting of at least one block (A) containing one or more iodinated end groups; and
a step (b) of polymerizing at least one fluorinated monomer, in the presence of a radical initiator and of the pre-polymer latex provided in step (a), thereby providing at least one block (B) chemically bound to said pre-polymer by means of reactivity of the said iodinated end group(s) of said pre-polymer.

In step (a) of the method of making the polymer (F-TPE) latex and/or possibly in the method of making the elastomer (F) latex, one or more iodinated chain transfer agents are added to the reaction medium, typically of formula RₓIₙ, wherein Rₓ is a C₁-C₁₆, preferably a C₁-C₈ (per)fluoroalkyl or a (per)fluorochloroalkyl group, and n is 1 or 2. It is also possible to use as chain transfer agents alkali or alkaline-earth metal iodides, as described in U.S. Pat. No. 5,173,553 (AUSIMONT S.P.A.) Dec. 22, 1992. The amount of the chain transfer agent to be added is established depending on the molecular weight which is intended to be obtained and on the effectiveness of the chain transfer agent itself.

In any of steps (a) and (b) of the method of making the polymer (F-TPE) latex and/or in the method of making the elastomer (F) latex, one or more surfactants may be used, preferably fluorinated surfactants of formula:

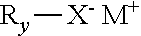

wherein R_{y} is a C₅-C₁₆ (per)fluoroalkyl or a (per)fluoropolyoxyalkyl group, X⁻ is —COO⁻ or —SO₃⁻, and M⁺ is selected from the group consisting of H⁺, NH₄⁺, and an alkali metal ion.

Among the most commonly used surfactants, mention can be made of (per)fluoropolyoxyalkylenes terminated with one or more carboxyl groups.

In the method of making the polymer (F-TPE), when step (a) is terminated, the reaction is generally discontinued, for instance by cooling, and the residual monomers are removed, for instance by heating the emulsion under stirring. The second polymerization step (b) is then advantageously carried out, feeding the new monomer(s) mixture and adding fresh radical initiator. If necessary, under step (b) of the process for the manufacture of the polymer (F-TPE), one or more further chain transfer agents may be added, which can be selected from the same iodinated chain transfer agents as defined above or from chain transfer agents known in the art for use in the manufacture of fluoropolymers such as, for instance, ketones, esters or aliphatic alcohols having from 3 to 10 carbon atoms, such as acetone, ethylacetate, diethylmalonate, diethylether and isopropyl alcohol; hydrocarbons, such as methane, ethane and butane; chloro(fluoro)carbons, optionally containing hydrogen atoms, such as chloroform and trichlorofluoromethane; bis(alkyl)carbonates wherein the alkyl group has from 1 to 5 carbon atoms, such as bis(ethyl) carbonate and bis(isobutyl) carbonate.

The method of making the polymer (F-TPE) latex and/or the method of making the elastomer (F) latex may be carried out in aqueous emulsion polymerization in the presence of a microemulsion of perfluoropolyoxyalkylenes, as described in U.S. Pat. No. 4,864,006 (AUSIMONT S.P.A.) Sep. 5, 1989, or in the presence of a microemulsion of fluoropolyoxyalkylenes having hydrogenated end groups and/or hydrogenated recurring units, as described in EP 625526 A (AUSIMONT S.P.A.) Nov. 23, 1994.

### The Step (A) of Mixing

Mixing can be effected in standard devices; vessels equipped with axial-flow impellers or radial-flow impellers, including multi-stage impellers, can be used, and vessel may be equipped with baffles, which converts some of the rotational motion into vertical motion.

Generally shear stress applied in Step (A) will be reasonably adapted for avoiding premature coagulation of the latexes to be mixed.

Mixing time and temperatures are not particularly critical; generally, mixing at temperatures of 20 to 60° C. is effective for providing mixture (L).

Mixing is carried out generally at a temperature of at least 5° C., preferably of at least 15° C., more preferably at least 20° ° C. and/or at a temperature of at most 80° C., preferably at most 70° C., more preferably at most 60° C., even more preferably at most 50° C.

It is nevertheless generally preferred to accomplish mixing around about room temperature, or generally between 15 and 30° C.

The method generally comprise mixing a latex of polymer (F-TPE) and a latex of elastomer (F) in such amounts that the latex-blended composition (C) generally comprises an amount of polymer (F-TPE) of at least 50% wt, preferably of at least 60% wt, more preferably of at least 70% wt, even more preferably of at least 75% wt and/or of at most 99% wt, preferably of at most 98% wt, more preferably at most 95% and even more preferably at most 90% wt, with respect to the combined weight of polymer (F-TPE) and elastomer (F).

Hence, conversely, the method generally comprise mixing a latex of polymer (F-TPE) and a latex of elastomer (F) in such amounts that the latex-blended composition (C) generally comprises an amount of elastomer (F) of at most 50% wt, preferably of at most 40% wt, more preferably of at most 30% wt, even more preferably of at most 25% wt and/or of at least 1% wt, preferably of at least 2% wt, more preferably at least 5% and even more preferably at least 10% wt, with respect to the combined weight of polymer (F-TPE) and elastomer (F).

### The Step (B) of Coagulating

In second step of the method of the invention, the mixture (L) can be coagulated by standard techniques.

The mixture (L) can be coagulated through addition of an electrolyte or through any electrolyte-free techniques of coagulation which are known to those of ordinary skills in the art.

Among electrolyte-free techniques, mention can be made of coagulation through high pressure compression/decompression, e.g. by forced flow through a series of restrained openings; of coagulation under high shear, e.g. under extremely vigorous stirring; and of coagulation by freeze/taw techniques.

Coagulation under high shear may be effected sequentially after mixing, by merely increasing shear stress applied by means of the mixing device used in Step (A).

It is nevertheless generally preferred to proceed with coagulating the mixture (L) by addition of an electrolyte. This addition is generally performed under stirring.

The choice of the electrolyte is not particularly limited, and electrolytes such as sulphuric acid, nitric acid, hydrochloridric acid, magnesium nitrate, aluminum sulphate may be used.

This being said, when metal contamination may be an issue, electrolyte will preferably selected from nitric acid and hydrochloridric acid, more preferably nitric acid.

A coagulate is so generated during this coagulation step, whose separation from the dispersing medium may be effected by using conventional techniques such as flotation, filtration, centrifugation, decantation, or a combination of these techniques.

The coagulate so recovered is generally dried using standard techniques, so as to advantageously remove residual moisture.

A composition (C) is hence so obtained.

### The Composition (C)

As said, the invention further pertains to a composition (C) comprising at least one polymer (F-TPE) and at least one elastomer (F), as detailed above, which may be obtained by the method as detailed above, wherein the said elastomer (F) is dispersed in the polymer (F-TPE) in a manner such that phase-separated and/or not cohered domains of elastomer (F) having a size exceeding 200 nm are substantially absent.

All features described above for the polymer (F-TPE), and elastomer (F) are applicable as relevant embodiment's of the composition (C) of the invention.

The expression “substantially absent” in combination with the amount of phase separated domains of elastomer (F) of size exceeding 200 nm is to be understood to mean that a SEM magnification of a fractured surface of the composition (C), when analyzed electronically by computerized image analysis, will account for a fraction of surface occupied by inclusions or physically separated domains having maximal dimension exceeding 200 nm of less than 3%, preferably less than 2%, even more preferably of less than 1%, with respect to the total area of the sample.

The expression ‘maximal dimension’ as associated to inclusions or physically separated domains is the maximum size derived from the distance of two tangents to the contour of the inclusions or physically separated domains, when assessing whichever orientation. In simpler words, this method corresponds to the measurement by a slide gauge of inclusions or physically separated domains.

The composition (C) generally comprises an amount of polymer (F-TPE) of at least 50% wt, preferably of at least 60% wt, more preferably of at least 70% wt, even more preferably of at least 75% wt and/or of at most 99% wt, preferably of at most 98% wt, more preferably at most 95% and even more preferably at most 90% wt, with respect to the combined weight of polymer (F-TPE) and elastomer (F).

Hence, conversely, composition (C) generally comprises an amount of elastomer (F) of at most 50% wt, preferably of at most 40% wt, more preferably of at most 30% wt, even more preferably of at most 25% wt and/or of at least 1% wt, preferably of at least 2% wt, more preferably at least 5% and even more preferably at least 10% wt, with respect to the combined weight of polymer (F-TPE) and elastomer (F).

The composition (C) may further additionally comprise ingredients which maybe commonly used for curing of fluororubbers; more specifically, composition (C) may generally further comprise
(a) one or more than one metallic basic compound, in amounts generally of from 0.5 to 15 phr, and preferably of from 1 to 10 phr, relative to 100 weight parts of combined weight of polymer (F-TPE) and elastomer (F); metallic basic compounds are generally selected from the group consisting of (j) oxides or hydroxides of divalent metals, for instance oxides or hydroxides of Mg, Zn, Ca or Pb, and (jj) metal salts of a weak acid, for instance Ba, Na, K, Pb, Ca stearates, benzoates, carbonates, oxalates or phosphites;
(b) one or more than one acid acceptor which is not a metallic basic compound, in amounts generally of from 0.5 to 15 phr, and preferably of from 1 to 10 phr, relative to 100 weight parts of combined weight of polymer (F-TPE) and elastomer (F); these acid acceptors are generally selected from nitrogen-containing organic compounds, such as 1,8-bis(dimethylamino)naphthalene, octadecylamine, etc., as notably described in EP 708797 A (DU PONT) Jan. 5, 1996;
(c) other conventional additives, such as fillers, thickeners, pigments, antioxidants, stabilizers, processing aids, and the like.

### Method of Fabricating Composition (C)

The invention also pertains to a method for fabricating shaped articles comprising processing in the melt the composition (C), as above described.

The composition (C) can be processed in the melt, e.g. by moulding (injection moulding, compression molding), calendering, or extrusion, into the desired shaped article.

Hence, the invention pertains to a method of making a shaped article comprising processing the composition (C), as above detailed, according any of injection moulding, compression moulding, extrusion, coating, screen printing technique, and form-in-place technique.

Yet, the invention pertains to shaped articles obtained from the composition (C), as above detailed. Said shaped articles may be sealing articles, including O(square)-rings, packings, gaskets, diaphragms, shaft seals, valve stem seals, piston rings, crankshaft seals, cam shaft seals, and oil seals or maybe piping and tubings, in particular flexible hoses or other items, including conduits for delivery of hydrocarbon fluids and fuels.

Further, shaped parts obtained from the composition (C) of the present invention may be components of different peripheral's, accessories and devices, intended for connection to mobile electronic devices.

The said shaped parts can be notably wrist bands, chest belts and other affixtures have been developed for securing electronic devices to specific part of human body.

The said shaped parts may be components of signal transmission cables, e.g. for transmitting/receiving electric signals generated in acoustic systems or imaging systems, which may be connected for use with earphones, headphones, speakers, or image display devices to portable electronics. Said shaped part can be notably a cable jacket or an outermost coating layer of the said signal transmission cables, which advantageously encloses all the components of the cable and protects them from the external environment, while at the same time it provides easy handling, flexibility and mechanical strength.

Yet, the shaped part may be a protective case designed to receive and hold a portable electronic device.

Still, the shaped part may be a component of an earbud, including those intended to be connected to portable electronic devices.

Should the disclosure of any patents, patent applications, and publications which are incorporated herein by reference conflict with the description of the present application to the extent that it may render a term unclear, the present description shall take precedence.

The invention will be now described in more details with reference to the following examples, whose purpose is merely illustrative and not intended to limit the scope of the invention.

### Raw Materials

### Preparative Example 1—Manufacture of Fluorinated Thermoplastic Elastomer (F-TPE-1)

In a 7.5 liters reactor equipped with a mechanical stirrer operating at 72 rpm, 4.5 l of demineralized water and 22 ml of a microemulsion, previously obtained by mixing 4.8 ml of a perfluoropolyoxyalkylene having acidic end groups of formula CF₂ClO(CF₂—CF(CF₃)O)ₙ(CF₂O)ₘCF₂COOH, wherein n/m=10, having an average molecular weight of 600, 3.1 ml of a 30% v/v NH4OH aqueous solution, 11.0 ml of demineralized water and 3.0 ml of GALDEN® D02 perfluoropolyether of formula CF₃O(CF₂CF(CF₃)O)ₙ(CF₂O)ₘCF₃, wherein n/m=20, having an average molecular weight of 450, were introduced.

The reactor was heated and maintained at a set-point temperature of 80° C.; a mixture of vinylidene fluoride (VDF) (78.5% moles) and hexafluoropropylene (HFP) (21.5% moles) was then added to reach a final pressure of 20 bar. Then, 8 g of 1,4-diodoperfluorobutane (C₄F₈I₂) as chain transfer agent were introduced, and 1.25 g of ammonium persulfate (APS) as initiator were introduced. Pressure was maintained at a set-point of 20 bar by continuous feeding of a gaseous mixture of vinylidene fluoride (VDF) (78.5% by moles) and hexafluoropropylene (HFP) (21.5% by moles) up to a total of 1600 g.

Once 1600 g of monomer mixture were fed to the reactor, the reaction was discontinued by cooling the reactor to room temperature. The residual pressure was then discharged and the temperature brought to 80° C. VDF was then fed into the autoclave up to a pressure of 20 bar, and 0.14 g of ammonium persulfate (APS) as initiator were introduced. Pressure was maintained at a set-point of 20 bar by continuous feeding of VDF up to a total of about 690 g. Then, the reactor was cooled, vented and the latex recovered. The latex was treated with aluminum sulphate, separated from the aqueous phase, washed with demineralized water and dried in a convection oven at 90° ° C. for 16 hours.

Thermal properties have been determined by differential scanning calorimetry pursuant to ASTM D3418 standard.

TABLE 1

| | | Pr. Ex. 1 |
|---|---|---|
| T_{g} | [° C.] | −17.3 |
| Tₘ | [° C.] | 159.2 |
| ΔHₘ | [J/g] | 12.6 |

| | | |
|---|---|---|
| Recurring units | block (A) | block (B) |

| | | | |
|---|---|---|---|
| fraction | [% wt] | 70 | 30 |
| VDF | [% mol] | 78.5 | 100 |
| HFP | [% mol] | 21.5 | — |

### Example 2—Preparation by Latexes Mixing

In a glass vessel, 680 g of latex of F-TPE-1, prepared according to the description in Example 1 (solid content 22%), were mixed together with 143 g of latex obtained from the polymerization of a fluorinated elastomer (F, solid content 35%) with monomeric composition corresponding to 78.5% moles vinylidene fluoride (VDF) and 21.5% moles hexafluoropropylene (HFP). The relative amount of F-TPE-1 and elastomer to be mixed were selected in such a way that the final material was made of 85% elastomeric phase (cumulative of elastomer and F-TPE-1 contributions) and 15% VDF homopolymer.

The mixture was stirred for 5 mins at room temperature with a four blades stirrer, at a stirring speed of 300 rpm.

The blend obtained by mixing said latexes was then dripped in a glass vessel containing, 2 litres of water in which 190 g of NaHCO₃ have been previously dissolved. During dripping, stirring was kept constant at 400 rpm. In this phase the blend coagulated.

At the end of dripping, stirring was continued for 5 minutes. The obtained solid was then separated from the aqueous phase and washed with clean demineralized water for four times.

After washing, the obtained material was dried at 70° C. for 24 h in drying oven.

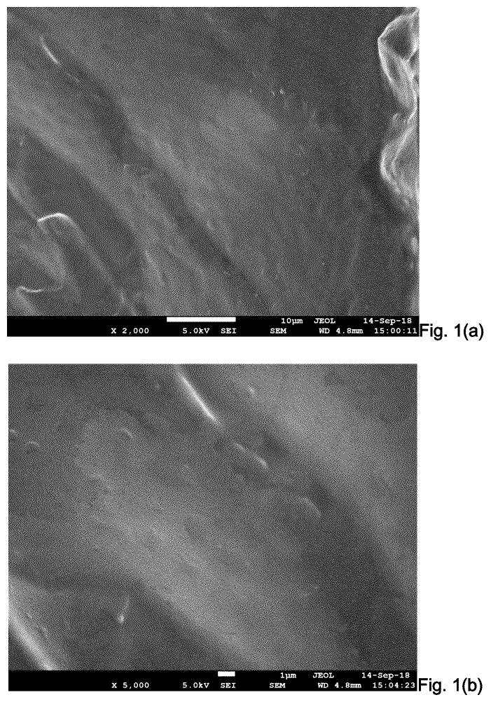

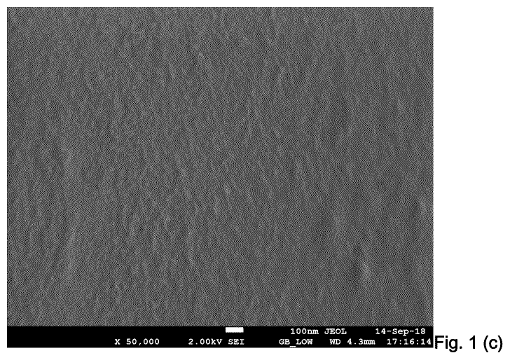

A specimen of so obtained blend was submitted to SEM microscopy analysis, showing substantial absence of domains phase-separated/not cohered with sizes of 200 nm or more (See FIG. 1).

### Comparative Example 3—Preparation of Blend by Solid Mixing

150 g of F-TPE-1 of preparative Ex. 1 in the form of dry flakes were heated and compacted by shear in an open mill mixer. The speed ratio between the two rolls was 1:1.41 and the temperature was controlled in such a way that the temperature of the polymer was between 50 and 70° C. 50 g of a fluorinated elastomer F in solid form, having a composition of composition corresponding to 78.5% moles vinylidene fluoride (VDF) and 21.5% moles hexafluoropropylene (HFP) were then added and mixed with the F-TPE-1. Roll mixing operations were continued for about 5 minutes. The blend of the two materials was recovered as a single sheet from the mixer and cooled to room temperature. The relative amount of F-TPE-1 and elastomer to be mixed were selected in such a way that the final material was made of 85% elastomeric fraction (cumulative of contribution from F-TPE-1 and fluoroelastomer) and 15% VDF homopolymer.

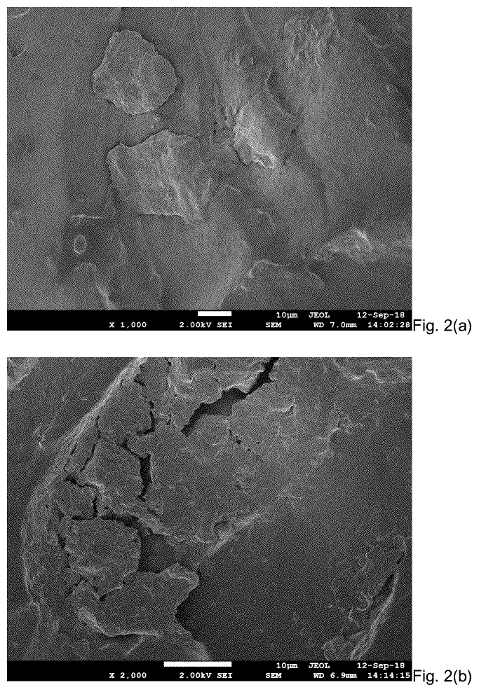

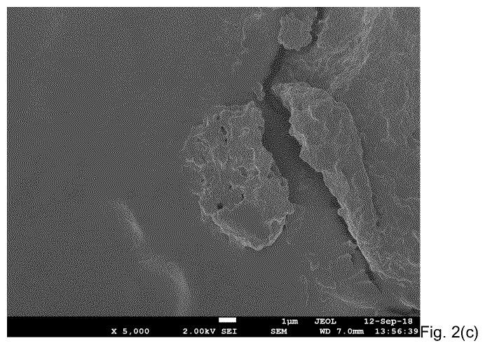

A specimen of so obtained blend was submitted to SEM microscopy analysis, showing presence of significant fraction of domains phase-separated/not cohered with sizes largely exceeding 200 nm (See FIG. 2).

### Example 4 of Comparison—Preparation by Polymerization of “Soft” Fluorinated Thermoplastic Elastomer

In a 705 l reactor, polymerization was run following procedure detailed above in Preparative Example 1. In this example of comparison, differently from Prep. Ex. 1, the first step of polymerization was run until 1700 g of the VDF/HFP monomer mixture had reacted, while the second step was run until 300 g of VDF monomer had reacted. The monomers ratio and amount were selected in such a way that the final material was made of 85% elastomeric fraction (VDF/HFP copolymer in 78.5/21.5 ratio) and 15% VDF homopolymer.

### Characterization of the Blends

Materials obtained from Examples 1, 2, 3 and 4 were molded with the compression molding method in 2 mm thick plaques, by hot pressing at 185° C. for five minutes under a pressure of 25 MPa.

The tensile properties have been determined on specimens punched out from the plaques, according to the DIN 53504 S2 Standard at 23° C.
TS is the tensile strength in MPa;
M₅₀ is the modulus in MPa at an elongation of 50%
M₁₀₀ is the modulus in MPa at an elongation of 100%;
EB is the elongation at break in %.
The Shore A hardness (3″) (HDS) has been determined on 3 pieces of plaque piled according to the ASTM D 2240 method.

Results are summarized in the following Table.

TABLE 2

| | Ex. 1C | Ex. 2 | Ex. 3C | Ex. 4C |
|---|---|---|---|---|
| TS [MPa] | 7.2 | 5.5 | 2.6 | 2.1 |
| M₅₀ [MPa] | 2.3 | 1.7 | 1.8 | 1.5 |
| M₁₀₀ [MPa] | 2.7 | 2.1 | 2.2 | 1.8 |
| EB [%] | 944 | 1015 | 510 | 656 |
| Shore A | 71 | 60 | 66 | 61 |

Data as above detailed well demonstrate that when aiming at lowering hardness and providing a softer material, the approach of latex blending a fluorinated thermoplastic elastomer and a fluorinated thermoplast is most effective in maximizing mechanical properties, in particular in maintaining high tensile strength; approaches consisting in adding by powder mixing similar amount of thermoplasts and/or consisting in modifying the weight fraction of soft/hard blocks in the fluorinated thermoplastic elastomer are not leading to similar advantageous hardness/strength compromise. This is well demonstrated considering that in Ex. 3C, mere compounding, although at strictly similar composition, is not delivering same softness but significantly detrimentally affecting the tensile strength when compared both to starting fluorinated thermoplastic elastomer alone, and to the inventive latex-blended solution. Further, a fluorinated thermoplastic elastomer possessing increased soft fraction, leading to targeted softness (i.e. reduced Shore A of about 60) possesses significantly poorer mechanical properties, in particular very low tensile strength, when compared to the inventive latex-blended solution.

1-15. (canceled)

16. A method of making a latex-blended composition [composition (C)] comprising:
a Step (A) a step of mixing:
an aqueous latex of at least one fluorinated thermoplastic elastomer [polymer (F-TPE)] comprising:
(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418, and
(ii) at least one thermoplastic block (B) consisting of a sequence of recurring units, said sequence comprising recurring units derived from at least one fluorinated monomer, wherein the crystallinity of said block (B) and its weight fraction in the polymer (F-TPE) are such to provide for a heat of fusion of the polymer (F-TPE) of at least 2.5 J/g, when determined according to ASTM D3418; and
an aqueous latex of at least one (per)fluoroelastomer [elastomer (F)] possessing a heat of fusion of less than 2.5 J/g, when determined according to ASTM D3418;
so as to obtain a latex mixture [mixture (L)]; and
a Step (B) of coagulating the said mixture (L), so as to obtain said composition (C).

17. The method of claim 16, wherein said polymer (F-TPE) comprises:
at least one elastomeric block (A) selected from the group consisting of:
(1) vinylidene fluoride (VDF)-based elastomeric blocks (A_{VDF}) consisting of a sequence of recurring units, said sequence comprising recurring units derived from VDF and recurring units derived from at least one fluorinated monomer different from VDF, said fluorinated monomer different from VDF being typically selected from the group consisting of:
(a) C₂-C₈ perfluoroolefins;
(b) hydrogen-containing C₂-C₈ fluoroolefins different from VDF;
(c) C₂-C₈ chloro- and/or bromo-containing fluoroolefins;
(d) perfluoroalkylvinylethers (PAVE) of formula CF₂—CFOR_{f1}, wherein R_{f1} is a C₁-C₆ perfluoroalkyl group;
(e) perfluorooxyalkylvinylethers of formula CF₂═CFOX₀, wherein X₀ is a C₁-C₁₂ perfluorooxyalkyl group comprising one or more than one ethereal oxygen atom; and
(f) (per)fluorodioxoles of formula: 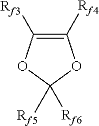
wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms; and
(2) tetrafluoroethylene (TFE)-based elastomeric blocks (A_{TFE}) consisting of a sequence of recurring units, said sequence comprising recurring units derived from TFE and recurring units derived from at least one fluorinated monomer different from TFE; and
at least one thermoplastic block (B) consisting of a sequence of recurring units derived from at least one fluorinated monomer.

18. The method of claim 16, wherein block (B) consists of a sequence of recurring units, said sequence comprising:
recurring units derived from one or more than one fluoromonomer selected from the group consisting of:
(a) C₂-C₈ perfluoroolefins;
(b) hydrogen-containing C₂-C₈ fluoroolefins;
(c) C₂-C₈ chloro- and/or bromo-containing fluoroolefins;
(d) perfluoroalkylvinylethers (PAVE) of formula CF₂—CFOR_{f1}, wherein R_{f1} is a C₁-C₆ perfluoroalkyl group;
(e) perfluorooxyalkylvinylethers of formula CF₂═CFOX₀, wherein X₀ is a C₁-C₁₂ perfluorooxyalkyl group comprising one or more than one ethereal oxygen atom; and
(f) (per)fluorodioxoles of formula: 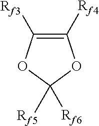
wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms; and
optionally, recurring units derived from one or more than one hydrogenated monomer, as above detailed.

19. The method according to claim 16, wherein elastomer (F) is selected from the group consisting of VDF-based copolymers, in which VDF is copolymerized with at least one additional monomer selected from the group consisting of monomers (a), (b) different from VDF, (c), (d), (e), (f), said VDF-based copolymers possibly also comprising recurring units derived from a bis-olefin [bis-olefin (OF)] having general formula: 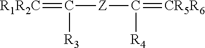
wherein R₁, R₂, R₃, R₄, R₅ and R₆, equal or different from each other, are H or C₁-C₅ alkyl; Z is a linear or branched C₁-C₁₈ (hydro)carbon radical (including alkylene or cycloalkylene radical), optionally containing oxygen atoms:
(a) C₂-C₈ perfluoroolefins;
(b) hydrogen-containing C₂-C₈ fluoroolefins;
(c) chloro- and/or bromo- and/or iodo-C₂-C₆ fluoroolefins;
(d) perfluoroalkylvinylethers (PAVE) of formula CF₂—CFOR_{f1}, wherein R_{f1} is a C₁-C₆ perfluoroalkyl group;
(e) perfluorooxyalkylvinylethers of formula CF₂—CFOX₀, wherein X₀ is a C₁-C₁₂ perfluorooxyalkyl group comprising one or more than one ethereal oxygen atom; and
(f) (per)fluorodioxoles of formula: 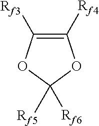
wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms.

20. The method according to claim 16, wherein the latex of polymer (F-TPE) comprises the polymer (F-TPE) in an amount of at least 15% wt., and/or in an amount of at most 60% wt, with respect to the total weight of latex; and/or wherein the latex of elastomer (F) comprises the elastomer (F) in an amount of at least 15% wt., and/or in an amount of at most 60% wt., with respect to the total weight of latex.

21. The method of claim 16, wherein mixing is effected at temperatures of 20 to 60° C.

22. The method of claim 16, which comprises mixing a latex of polymer (F-TPE) and a latex of elastomer (F)
(i) in such amounts that the latex-blended composition (C) comprises an amount of polymer (F-TPE) of at least 50% wt, and/or of at most 99% wt, with respect to the combined weight of polymer (F-TPE) and elastomer (F); and/or
(ii) in such amounts that the latex-blended composition (C) generally comprises an amount of elastomer (F) of at most 50% wt, and/or of at least 1% wt, with respect to the combined weight of polymer (F-TPE) and elastomer (F).

23. The method of claim 16, whereas mixture (L) is coagulated through addition of an electrolyte or through any electrolyte-free techniques of coagulation.

24. A latex-blended composition obtained from the method according to claim 16.

25. A composition comprising:
at least one fluorinated thermoplastic elastomer [polymer (F-TPE)] comprising:
(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418, and
(ii) at least one thermoplastic block (B) consisting of a sequence of recurring units, said sequence comprising recurring units derived from at least one fluorinated monomer, wherein the crystallinity of said block (B) and its weight fraction in the polymer (F-TPE) are such to provide for a heat of fusion of the polymer (F-TPE) of at least 2.5 J/g, when determined according to ASTM D3418; and
at least one (per)fluoroelastomer [elastomer (F)] possessing a heat of fusion of less than 2.5 J/g, when determined according to ASTM D3418;
wherein the said elastomer (F) is dispersed in the polymer (F-TPE) in a manner such that phase-separated domains and/or not cohered domains of elastomer (F) having a size exceeding 200 nm are substantially absent.

26. The composition of claim 25, said composition additionally comprising:
(a) one or more than one metallic basic compound, in amounts generally of from 0.5 to 15 phr, relative to 100 weight parts of combined weight of polymer (F-TPE) and elastomer (F); metallic basic compounds are generally selected from the group consisting of (j) oxides or hydroxides of divalent metals, for instance oxides or hydroxides of Mg, Zn, Ca or Pb, and (jj) metal salts of a weak acid, for instance Ba, Na, K, Pb, Ca stearates, benzoates, carbonates, oxalates or phosphites; and/or
(b) one or more than one acid acceptor which is not a metallic basic compound, in amounts generally of from 0.5 to 15 phr, relative to 100 weight parts of combined weight of polymer (F-TPE) and elastomer (F); and/or
(c) other conventional additives.

27. A method for fabricating shaped articles comprising processing in the melt the composition (C) obtained from the method according to claim 16, said method comprising processing said composition (C) according to any of injection moulding, compression moulding, extrusion, coating, screen printing technique, and form-in-place technique.

28. A shaped article obtained from the composition (C), obtained from the method according to claim 16.

29. The shaped article of claim 28, which is selected from the group consisting of sealing articles, including O(square)-rings, packings, gaskets, diaphragms, shaft seals, valve stem seals, piston rings, crankshaft seals, cam shaft seals, and oil seals or maybe piping and tubings, in particular flexible hoses or other items, including conduits for delivery of hydrocarbon fluids and fuels.

30. The shaped article of claim 28, which is selected from the group consisting of components of different peripheral's, accessories and devices, intended for connection to mobile electronic devices, and in particular selected from the group consisting of:
wrist bands, chest belts and other affixtures have been developed for securing electronic devices to specific part of human body;
components of signal transmission cables, e.g. for transmitting/receiving electric signals generated in acoustic systems or imaging systems, which are connected for use with earphones, headphones, speakers, or image display devices to portable electronics;
a protective case designed to receive and hold a portable electronic device;
a component of an earbud, including those intended to be connected to portable electronic devices.

31. A method for fabricating shaped articles comprising processing in the melt the composition (C) according to claim 25, said method comprising processing said composition (C) according to any of injection moulding, compression moulding, extrusion, coating, screen printing technique, and form-in-place technique.

32. A shaped article obtained from the composition (C) according to claim 25.

33. The shaped article of claim 32, which is selected from the group consisting of sealing articles, including O(square)-rings, packings, gaskets, diaphragms, shaft seals, valve stem seals, piston rings, crankshaft seals, cam shaft seals, and oil seals or maybe piping and tubings, in particular flexible hoses or other items, including conduits for delivery of hydrocarbon fluids and fuels.

34. The shaped article of claim 32, which is selected from the group consisting of components of different peripheral's, accessories and devices, intended for connection to mobile electronic devices, and in particular selected from the group consisting of:
wrist bands, chest belts and other affixtures have been developed for securing electronic devices to specific part of human body;
components of signal transmission cables, e.g. for transmitting/receiving electric signals generated in acoustic systems or imaging systems, which are connected for use with earphones, headphones, speakers, or image display devices to portable electronics;
a protective case designed to receive and hold a portable electronic device;
a component of an earbud, including those intended to be connected to portable electronic devices.
